(19) United States
(12) Patent Application Publication
(10) Pub. No.: US 2026/0180823 A1
(43) Pub. Date: Jun. 25, 2026

(54) COMPUTER NETWORK SYSTEM AND TASK SCHEDULING SYSTEM AND METHOD

(71) Applicant: Zhejiang University, Hangzhou (CN)

(72) Inventors: Yiyi MA, Hangzhou (CN); Chenhao YANG, Hangzhou (CN); Qi ZHANG, Hangzhou (CN); Tuqiao ZHANG, Hangzhou (CN)

(21) Appl. No.: 19/273,086

(22) Filed: Jul. 17, 2025

(30) Foreign Application Priority Data
Dec. 20, 2024 (CN) 202411889884.0

(51) Int. Cl. H04L 12/40; G06F 9/48; G06F 9/50

(52) U.S. Cl. CPC H04L 12/40013; G06F 9/4881; G06F 9/5027

(57) ABSTRACT

A computer network system and a task scheduling system and method are provided. The computer network system includes a plurality of computers without shunt jumper components, and a computer provided with a shunt jumper component is arranged between every two adjacent computers without the shunt jumper components. Each of the computers is provided with two central processing units, and each of the central processing units is connected to a high-speed network interface card. The task scheduling method is employed for scheduling, a single-node computing task is allocated to a shunted computer provided with the shunt jumper component, and remaining computers are configured to execute single-node and/or multi-node computing tasks. Upon completion of task execution, shunt jumper wires are disconnected through a shunt controller, such that adjacent nodes are communicated through the high-speed network interface card. All the computers equipped with the shunt jumper components execute single-node computing tasks.

### CROSS-REFERENCE TO RELATED APPLICATIONS

The present application claims priority to Chinese Patent Application No. 202411889884.0, filed on Dec. 20, 2024, the entire disclosure of which is incorporated herein by reference.

### TECHNICAL FIELD

The present disclosure relates to a computer network system and a task scheduling system and method.

### BACKGROUND

In the field of high-performance computing, computing tasks are mainly computationally intensive and require efficient computing resource support. Scheduling of computing tasks usually depends on a task scheduling system of a platform, and the computing tasks are reasonably allocated and executed at a plurality of computing nodes in a computing cluster. However, requirements for computing resources are different for each computing task, and the requirements for computing resources include the number of CPU cores. When execution of each computing task based on required resources starts, interruption or migration of the computing task is not allowed, and once any interruption occurs, re-execution of the computing task is required. The task scheduling system is configured mainly to allocate reasonable computing resources for tasks through the computing platform according to task requirements for computing resources and start execution of the tasks. However, when the computing platform is heavily loaded, the task scheduling system maybe fails to provide sufficient computing resources for all tasks in a timely manner. The tasks without allocated resources are placed in a waiting queue, awaiting release of computing resources. Task scheduling mechanisms of the prior art effectively manage the allocation of computing resources in most cases, but in some scenarios, particularly when resources are severely scarce, there still exist the problems such as low resource utilization efficiency and prolonged task execution delay.

At present, there are no shunt jumper wires and shunt controllers in the prior art, and traditional bridged network interface card-based solutions are commonly used, where computing nodes are communicated through the L2 data link layer. Although interconnection between different computing nodes is achieved, inherent latency and bandwidth bottlenecks exist due to the operating principle factors, which become more prominent particularly in the ring-based network topology. In latency-sensitive application scenarios, traditional bridged network interface card connection methods fail to meet the needs of efficient data transmission, which limits the overall performance of the computing platform, particularly during execution of high-concurrency, large-scale computing tasks.

### SUMMARY

In order to overcome the defects of the prior art, the present disclosure provides a computer network system and a task scheduling system and method. In the computer network system, approximately half of computers are provided with shunt jumper components, and all the computers equipped with the shunt jumper components execute single-node computing tasks, such that the whole computer network achieves flexible scheduling, and other nodes remain unblocked after single-node occupation, thereby improving hardware utilization efficiency.

To achieve the above objective, the present disclosure provides a computer network system, the computer network system includes a plurality of computers without shunt jumper components, a computer provided with a shunt jumper component is arranged between every two adjacent computers without the shunt jumper components, each of the computers without the shunt jumper components or each of the computers equipped with the shunt jumper components is provided with two central processing units, each of the central processing units is connected to a high-speed network interface card, and the high-speed network interface cards between the computers without the shunt jumper components and the computers equipped with the shunt jumper components form a ring-based network topology through wired connections; when the computers equipped with shunt jumper components are not shunted (jumper-connected), the computer not shunted is communicated with two adjacent computers without the shunt jumper components through the high-speed network interface card; and when at least one of the computers equipped with the shunt jumper components is shunted, the two computers without the shunt jumper components adjacent to the shunted computer are directly communicated at a physical layer through the shunt jumper component.

Further, each of the shunt jumper components includes a shunt jumper wire and a shunt controller, where the shunt jumper wire is a conductive wire connected between two high-speed network interface cards of the computer and is configured to control a circuit connection state, and the shunt controller is a logic circuit configured to detect states of the shunt jumper wires and related instructions, where the related instructions include identifying and changing a shunted state of the shunt jumper wire.

Further, when at least one of the computers equipped with the shunt jumper components is shunted, the remaining computers without the shunt jumper components and the computers equipped with the shunt jumper components and not shunted still form the ring-based network topology through wired connections.

The present disclosure further provides a task scheduling system containing the computer network system, and the task scheduling system includes a task scheduling manager, where the task scheduling manager is configured to receive tasks and allocate computer resources for the received tasks, and the computers refer to computers without the shunt jumper components and the computers equipped with the shunt jumper components in the computer network system, which are configured to compute the allocated tasks.

Further, the task scheduling manager includes a task queue, a task scheduler, and a node manager; where
the task queue is configured to receive task requests, sort a plurality of task requests according to a sorting principle defined in a task scheduling strategy, and initiate a task computing request to the task scheduler after acquiring a task sorting status, where the task computing request includes the required number of computing nodes;
the task scheduler is configured to initiate a request for the number of computing nodes to the node manager, and after controlling a corresponding number of the computers equipped with the shunt jumper components to be shunted or not shunted, allocate a corresponding number of computing nodes from the available computing nodes returned by the node manager according to the task computing request; and
the node manager is configured to manage all computers in the computer network system, and return the available computing nodes to the task scheduler according to the request for the number of computing nodes sent by the task scheduler, where the available computing nodes include the computers without the shunt jumper components and the computers equipped with the shunt jumper components but not shunted.

The present disclosure further provides a task scheduling method, and the method includes the following steps:
step 1: receiving a task submission instruction sent by a client, where the task submission instruction includes computing requirements for submitted tasks, and the computing requirements include the number of computing nodes;
step 2: placing the received tasks into the task queue through the task scheduling manager, where the received tasks are sorted in the task queue according to an order of entry;
step 3: determining the number M of available computing nodes through the task scheduling manager, determining the number m of computing nodes required for a first task in the task queue, and allocating a corresponding number of nodes to start execution of the task;
step 4: retrieving the number of computing nodes required for a first task in the updated task queue, and searching for a corresponding number of target nodes in the remaining M-m computing nodes; when matching conditions are met, allocating the corresponding target nodes to start execution of the task; and
step 5: when remaining computing nodes are fully allocated according to the step 4 or the remaining computing nodes fail to meet computing requirements for a task in the task queue, releasing computing resources from corresponding computing nodes after termination of on-going tasks, and then reallocating computing nodes for pending tasks scheduled.

Further, in the steps 3 and 4, tasks are classified according to the required number of computing nodes to form corresponding node computing tasks, when a task is classified as a single-node computing task, the task scheduler controls at least one computer equipped with the shunt jumper component from available computing nodes to be shunted, and the single-node computing task is allocated to the shunted computer.

The above technical solution employed by the present disclosure has the following technical effects: The high-performance computing network in the present disclosure includes a plurality of computers without the shunt jumper components and computers equipped with the shunt jumper components, and through activation and deactivation of the shunt jumper components, two computers without the shunt jumper components adjacent to the shunted computer are directly communicated at the physical layer through the shunt jumper component. Many defects of the prior art are overcome. In the prior art, only two network interface cards are used for bridging, and the bridged network interface cards achieve device communication at the L2 layer, resulting in data transmission latency longer than that of the present disclosure by approximately an order of magnitude; and the bottleneck of low efficiency in latency-sensitive applications such as high-performance computing and direct memory access in the ring network is overcome.

In the present disclosure, a computer equipped with the shunt jumper component is installed between two computers without the shunt jumper components, such that approximately half of the computers equipped with the shunt jumper components execute single-node computing tasks after shunt, and the whole computer network achieves flexible scheduling.

After a computer equipped with the shunt jumper component is shunted, remaining computers maintain consistent circuit conditions with minimized latency differences, thereby avoiding performance bottleneck.

The present disclosure further provides a task scheduling method. According to the task scheduling method, a single-node computing task is allocated to a computer equipped with the shunted jumper component and shunted, and remaining computing nodes still form a ring topology, which enables to execute one or more other computing tasks, achieves flexible scheduling based on a ring topology computer cluster, and ensures that other nodes remain unblocked after single-node occupation. The task scheduling method is suitable for high-performance computing tasks such as fluid simulation.

### BRIEF DESCRIPTION OF THE DRAWINGS

FIG. 1 is a schematic diagram of a computer network system.

FIG. 2 is a schematic diagram of a workflow of a task scheduling system containing a computer network system.

FIG. 3 is a schematic diagram of a task scheduling method.

Reference numerals in the accompanying drawings: 1. computer without shunt jumper component; 2. computer equipped with shunt jumper component; 3. high-speed network interface card; 4. shunt jumper wire; and 5. shunt controller.

### DETAILED DESCRIPTIONS OF THE EMBODIMENTS

In order to further describe the technical means adopted by the present disclosure to achieve intended objectives and also the effects, specific embodiments, structure, features, and effects of the present disclosure are described in detail below with reference to the accompanying drawings and preferred examples.

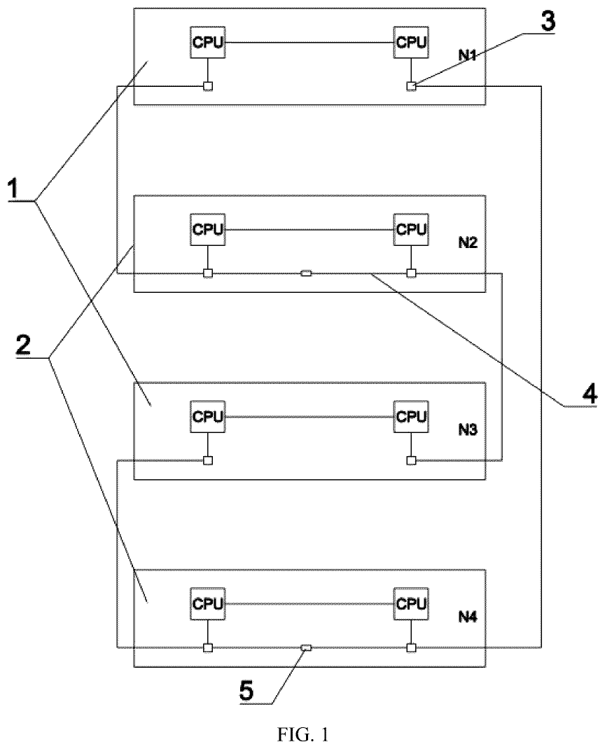

With reference to FIG. 1, the present disclosure provides a computer network system, including a high-performance computing network, and the high-performance computing network includes a plurality of computers without shunt jumper components, where a computer equipped with a shunt jumper component is arranged between every two adjacent computers without the shunt jumper components (in the present disclosure, four computers as shown in FIG. 1 are deployed, and the four computers are sequentially labeled as N1, N2, N3, and N4 from top to bottom), each of the computers without the shunt jumper components and the computers equipped with the shunt jumper components is provided with two central processing units, each of the central processing units is connected to a high-speed network interface card, and each of the central processing units is connected to a network interface card, such that the CPU load is more balanced. The high-speed network interface cards between the computers without the shunt jumper components and the computers equipped with the shunt jumper components form a ring-based network topology through wired connections, and the wired connections include a high-speed copper cable connection or an optical fiber connection. An appropriate spacing between the shunt jumper components ensures that approximately half of the computers in the computer network system execute single-node computing tasks, such that the whole computer network achieves flexible scheduling; and when all the shunt jumper components are shunted (jumper-connected), remaining computers without the shunt jumper components maintain consistent circuit conditions with minimized latency differences after shunt, thereby avoiding performance bottleneck. Spaced installation effectively reduces direct interference between adjacent computing nodes, minimizes signal reflection and crosstalk, optimizes signal quality, and enhances network reliability; and additionally, the spaced installation enables to make full use of physical space actually deployed, facilitates maintenance and management, and ensures no adverse impact on the overall performance of complex computing network systems. Each of the shunt jumper components includes a shunt jumper wire and a shunt controller, where the shunt jumper wire is a conductive wire, the shunt jumper wire is mounted between two high-speed network interface cards of the computer and configured to control a circuit connection state, and the shunt controller is a logic circuit configured to detect states of the shunt jumper wires and related instructions, where the related instructions include identifying and changing a shunted state of the shunt jumper wire; when all the computers equipped with the shunt jumper components are not shunted, the computer not shunted is communicated with two adjacent computers without the shunt jumper components through the high-speed network interface card, and all the computers form a ring-based network topology (i.e., N1-N2-N3-N4-N1); when at least one of the computers equipped with the shunt jumper components is shunted (N2 is arranged to be shunted), the two computers without the shunt jumper components adjacent to the shunted computer are directly communicated at a physical layer through the shunt jumper component, and the remaining computers without the shunt jumper components and the computers equipped with the shunt jumper components and not shunted jointly form a ring-based network topology (i.e., N1-N3-N4-N1); and the shunted computer (N2) independently executes single-node computing tasks.

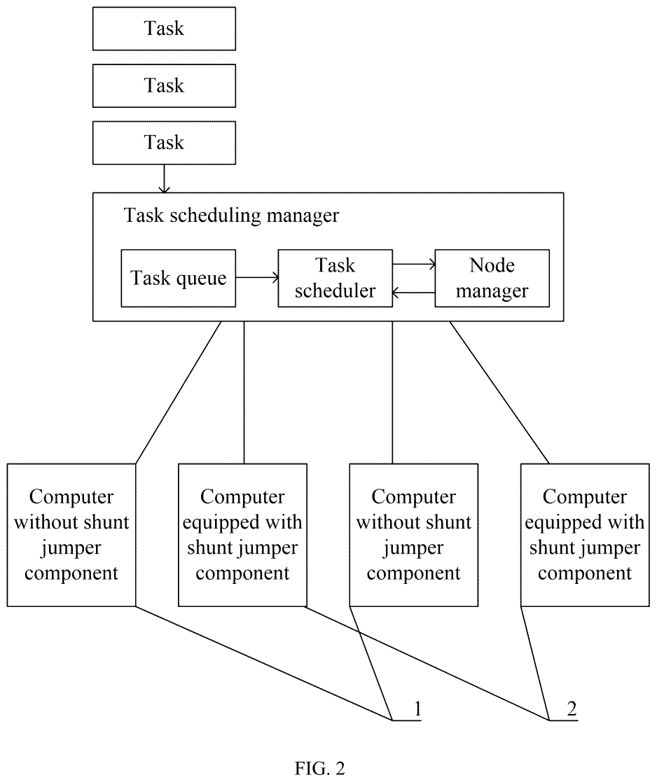

As shown in FIG. 2, the present disclosure further provides a task scheduling system containing the computer network system, and the task scheduling system includes a task scheduling manager, where the task scheduling manager is configured to receive tasks and allocate computing nodes without the shunt jumper components and/or computing nodes equipped with the shunt jumper components (the computing nodes are equivalent to the computers) for the received tasks, and the computers without the shunt jumper components and the computers equipped with the shunt jumper components in the computer network system are configured to compute the allocated tasks. Specifically, the task scheduling manager includes a task queue, a task scheduler, and a node manager, where the task queue is configured to receive task requests and sort a plurality of task requests according to a sorting principle defined in a task scheduling strategy, and a first-come, first-served scheduling algorithm is adopted.

The task scheduler is configured to initiate a request for the number of computing nodes to the node manager, and after controlling a corresponding number of the computers equipped with the shunt jumper components to be shunted or not shunted, allocate a corresponding number of computing nodes from the available computing nodes returned by the node manager according to the task computing request.

The node manager is configured to manage all computers in the computer network system, and return the available computing nodes to the task scheduler according to the request for the number of computing nodes sent by the task scheduler, where the available computing nodes include the computers without the shunt jumper components and the computers equipped with the shunt jumper components but not shunted.

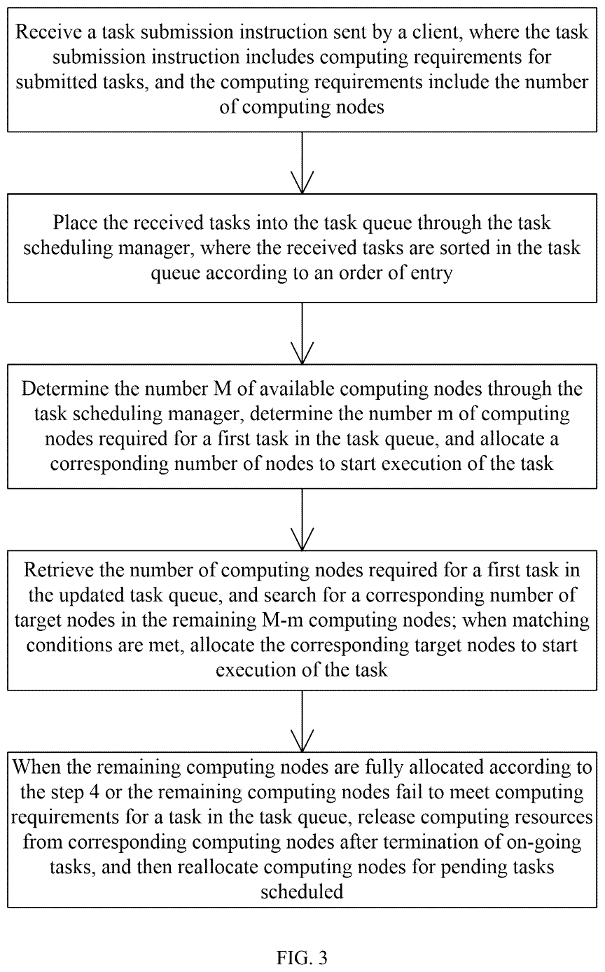

As shown in FIG. 3, the present disclosure further provides a task scheduling method, and the method includes the following steps:
step 1: receive a task submission instruction sent by a client, where the task submission instruction includes computing requirements for submitted tasks, and the computing requirements include the number of computing nodes;
step 2: place the received tasks into the task queue through the task scheduling manager, where the received tasks are sorted in the task queue according to an order of entry;
step 3: determine the number M of available computing nodes through the task scheduling manager, determine the number m of computing nodes required for a first task in the task queue, and allocate a corresponding number of nodes to start execution of the task;
step 4: retrieve the number of computing nodes required for a first task in the updated task queue, and search for a corresponding number of target nodes in the remaining M-m computing nodes; when matching conditions are met, allocate the corresponding target nodes to start execution of the task; and
step 5: when the remaining computing nodes are fully allocated according to the step 4 or the remaining computing nodes fail to meet computing requirements for a task in the task queue, release computing resources from corresponding computing nodes after termination of on-going tasks, and then reallocate computing nodes for pending tasks scheduled.

Specifically, tasks are classified according to the required number of computing nodes to form corresponding node computing tasks, when a task is classified as a single-node computing task, the task scheduler controls one computer equipped with the shunt jumper component from available computing nodes to be shunted, and the single-node computing task is allocated to the shunted computing node.

In the present disclosure, through the task scheduling method and the task scheduling system, single-node computing tasks are allocated to the computers equipped with the shunted jumper components and shunted, remaining computing nodes without the shunted jumper components and computing nodes equipped with the shunted jumper components and not shunted still execute single-node computing tasks or multi-node computing tasks, thereby achieving the technical effect that other nodes remain unblocked after single-node occupation. For example, when all computing nodes (taking four computing nodes as an example) are currently idle, in this case, when the task scheduling manager receives tasks 1, 2, 3, . . . n, all the computers equipped with the shunted jumper components and not shunted allocate resources of all four computing nodes to the task 1 when the task 1 is a four-node computing task, any other remaining task cannot be executed before completion of the task 1, and then computing resources released from corresponding computing nodes are reallocated to a pending task scheduled according to the task scheduling strategy.

When the task 1 is a three-node computing task, one of the computers equipped with the shunt jumper component is controlled to be shunted, such that the remaining three computing nodes form a ring and the three computing nodes are allocated to the task 1; and when the task 2 is a single-node computing task, the task scheduler allocates the shunted computing nodes to the task 2, but when the task 2 is a multi-node computing task, any other remaining task cannot be executed before completion of the task 1, and then computing resources released from corresponding computing nodes are reallocated to the pending task 2 scheduled according to the task scheduling strategy.

The foregoing descriptions are merely preferred examples of the present disclosure, and are not intended to impose any formal restrictions on the present disclosure. Although the present disclosure has been disclosed in preferred examples, they are not intended to limit the present disclosure. Without departing from the scope of the technical solution of the present disclosure, any person skilled in the art may make many possible changes to the technical solution by using the above disclosed technical contents, or modify the technical solution into equivalent examples with equivalent changes. Therefore, any simple alterations, equivalent changes and modifications which are made to the above examples in accordance with the technical essence of the present disclosure without departing from the contents of the technical solution of the present disclosure all fall within the scope of protection of the technical solution of the present disclosure.

What is claimed is:

1. A computer network system, comprising a plurality of computers without shunt jumper components, wherein a computer provided with a shunt jumper component is arranged between every two adjacent computers without the shunt jumper components, each of the computers without the shunt jumper components or each of the computers equipped with the shunt jumper components is provided with two central processing units, each of the central processing units is connected to a high-speed network interface card, and the high-speed network interface cards between the computers without the shunt jumper components and the computers equipped with the shunt jumper components form a ring-based network topology through wired connections; when the computers equipped with the shunt jumper components are not shunted (jumper-connected), the computer not shunted is communicated with two adjacent computers without the shunt jumper components through the high-speed network interface card; when at least one of the computers equipped with the shunt jumper components is shunted, the two computers without the shunt jumper components adjacent to the shunted computer are directly communicated at a physical layer through the shunt jumper component, and the remaining computers without the shunt jumper components and the computers equipped with the shunt jumper components and not shunted still form the ring-based network topology through wired connections; and
each of the shunt jumper components comprises a shunt jumper wire and a shunt controller, wherein the shunt jumper wire is a conductive wire connected between two high-speed network interface cards of the computer and is configured to control a circuit connection state, and the shunt controller is a logic circuit configured to detect states of the shunt jumper wires and related instructions, wherein the related instructions comprise identifying and changing a shunted state of the shunt jumper wire.

2. A task scheduling system containing the computer network system according to claim 1, comprising a task scheduling manager, wherein the task scheduling manager is configured to receive tasks and allocate computer resources for the received tasks, and the computers without the shunt jumper components and the computers equipped with the shunt jumper components in the computer network system are configured to compute allocated tasks.

3. The task scheduling system according to claim 2, wherein the task scheduling manager comprises a task queue, a task scheduler, and a node manager; wherein
the task queue is configured to receive task requests, sort a plurality of task requests according to a sorting principle defined in a task scheduling strategy, and initiate a task computing request to the task scheduler after acquiring a task sorting status, wherein the task computing request comprises the required number of computing nodes;
the task scheduler is configured to initiate a request for the number of computing nodes to the node manager, and after controlling a corresponding number of the computers equipped with the shunt jumper components to be shunted or not shunted, allocate a corresponding number of computing nodes from the available computing nodes returned by the node manager according to the task computing request; and
the node manager is configured to manage all computers in the computer network system, and return the available computing nodes to the task scheduler according to the request for the number of computing nodes sent by the task scheduler, wherein the available computing nodes comprise the computers without the shunt jumper components and the computers equipped with the shunt jumper components but not shunted.

4. A task scheduling method based on the task scheduling system according to claim 3, comprising the following steps:
step 1: receiving a task submission instruction sent by a client, wherein the task submission instruction comprises computing requirements for submitted tasks, and the computing requirements comprise the number of computing nodes;
step 2: placing the received tasks into the task queue through the task scheduling manager, wherein the received tasks are sorted in the task queue according to an order of entry;
step 3: determining the number M of available computing nodes through the task scheduling manager, determining the number m of computing nodes required for a first task in the task queue, and allocating a corresponding number of nodes to start execution of the task;
step 4: retrieving the number of computing nodes required for a first task in the updated task queue, and searching for a corresponding number of target nodes in remaining M-m computing nodes; when matching conditions are met, allocating corresponding target nodes to start execution of the task; and
step 5: when remaining computing nodes are fully allocated according to the step 4 or the remaining computing nodes fail to meet computing requirements for a task in the task queue, releasing computing resources from corresponding computing nodes after termination of on-going tasks, and then reallocating computing nodes for pending tasks scheduled.

5. The task scheduling method according to claim 4, wherein in the steps 3 and 4, tasks are classified according to the required number of computing nodes to form corresponding node computing tasks, when a task is classified as a single-node computing task, the task scheduler controls at least one computer equipped with the shunt jumper component from available computing nodes to be shunted, and the single-node computing task is allocated to the shunted computer.
